(19) United States
(12) Patent Application Publication
(10) Pub. No.: US 2022/0048171 A1
(43) Pub. Date: Feb. 17, 2022

(54) TOOL TO REMOVE PAD FROM UNDERNEATH INSTALLED OR PARTIALLY REMOVED CARPET

(71) Applicants: Darren Russell Foote, Reno, NV (US); Ryan Harold Foote, Centerton, AR (US); Gabe Arthur Foote, Reno, NV (US)

(72) Inventors: Darren Russell Foote, Reno, NV (US); Ryan Harold Foote, Centerton, AR (US); Gabe Arthur Foote, Reno, NV (US)

(21) Appl. No.: 17/403,463

(22) Filed: Aug. 16, 2021

Related U.S. Application Data
(60) Provisional application No. 63/066,224, filed on Aug. 15, 2020.

(51) Int. Cl. B25B 27/14; E04G 23/00

(52) U.S. Cl. CPC B25B 27/14; B25G 1/04; E04G 23/006

(57) ABSTRACT

Carpet pad removal tools may include a handle and a headplate coupled to the handle. The headplate may include a plurality of teeth along an edge of the headplate that is angled relative to the rest of the headplate. Other aspects, embodiments, and features are also included.

### CROSS REFERENCE TO RELATED APPLICATIONS

This application is a non-provisional of and claims priority to U.S. Provisional Patent Application No. 63/066,224 filed Aug. 15, 2020, the entire contents of which are incorporated by reference herein for all purposes.

### TECHNICAL FIELD

This disclosure relates to the field of the removal of carpet padding from underneath installed or partially removed existing carpet.

### BRIEF SUMMARY OF SOME EXAMPLES

The present disclosure provides a carpet pad removal tool and methods of making and using the carpet pad removal tool. According to at least one example, a carpet pad removal tool may include a handle, and a headplate coupled to the handle. The headplate may include a plurality of teeth along an edge thereof.

The above features and advantages of the present disclosure will be better understood from the following detailed description taken in conjunction with the accompanying drawings.

### BRIEF DESCRIPTION OF THE DRAWINGS

FIG. 1 is a perspective view of a tool to remove pad from underneath installed or partially removed carpet

FIG. 2 illustrates an enlarged view of the teeth on the headplate of a tool to remove pad from underneath installed or partially removed carpet

FIG. 3 illustrates an exploded (disassembled) bottom view of a tool to remove pad from underneath installed or partially removed carpet

FIG. 4 illustrates a top view of a tool to remove pad from underneath installed or partially removed carpet

FIG. 5 illustrates a side view of a tool to remove pad from underneath installed or partially removed carpet

FIG. 6 illustrates a bottom view of a tool to remove pad from underneath installed or partially removed carpet

### DETAILED DESCRIPTION

The present disclosure will now be discussed in detail with regard to the attached drawing figures that were briefly described above. In the following description, numerous specific details are set forth illustrating the Applicant's best mode for practicing one or more embodiments, and enabling one of ordinary skill in the art to make and use the various disclosed embodiments. It will be obvious, however, to one skilled in the art that the present disclosure may be practiced without many of these specific details. In other instances, well-known machines, structures, and method steps have not been described in particular detail in order to avoid unnecessarily obscuring the present disclosure. Unless otherwise indicated, like parts and method steps are referred to with like reference numerals.

Carpet represents a significant investment for home and business owners and is expensive to replace if damaged due to being mishandled when removing the affected pad underneath. When carpet and pad, cushion, and/or underlay, referred to herein as pad or padding, are affected by water damage the goal is to save the carpet and to remove and replace the pad underneath. Removing affected pad is a best practice to allow for a quicker and proper drying process.

When carpet is wet it is the most susceptible to damage, which occurs during the process of removing the pad. This process involves lifting, manipulating and removing the carpet from the tack strip and/or cutting seams in the carpet to access and remove the wet padding. The disclosed embodiments include a developed tool to remove the pad from underneath installed or partially removed carpet, reducing the need to completely uninstall carpet as well as reducing the need to cut carpet seams.

The common method to remove pad is to first remove carpet from the tack strips, then fold, roll or bend the carpet as needed to remove the pad, put the carpet back in place and repeat until all or substantially all of the affected pad is removed. Cutting a seam in the carpet is a common practice when removing pad in tight areas, such as doorways, hallways, etc. Without cutting a seam it can be difficult or impossible to remove the affected pad. While this method works, it also presents Multiple issues.

Several non-limiting examples follow. Cutting carpet seams can result in permanent damage to the carpet or difficulty in re-seaming and reinstalling the carpet in an acceptable manner. Carpet is extremely delicate when wet and is easily damaged the more it is manipulated (e.g., lifting, rolling, bending, twisting, folding, stretching, wadding, etc.). When disengaging and removing wet carpet from the tack strip it is easy to delaminate the primary and secondary backing of the carpet causing irreversible structural damage. During the drying process, carpet often remains on site to be dried, with airflow directed underneath it. This airflow can cause the carpet that has been uninstalled or has a seam that has been cut to easily move or flap against the floor, wall or tack strips, causing damage to the carpet. Depending on the cleanliness of the water, carpet can often be salvaged, unless the carpet remains wet or is damaged due to removing the pad.

The tools described in relation to the disclosed embodiments provide several advantages over the existing and prior art. Specifically, these embodiments allow for all or substantially all affected pad to be removed without uninstalling a majority of the carpet from the tack strips. Leaving a large portion of the carpet installed allows for less manipulation which reduces the risk of delamination and damage to the carpet.

In tight or restrictive areas such as hallways, doorways, closets, etc., the disclosed embodiments have the advantage of being able to remove the pad without cutting seams. Without the tools used in these embodiments, the common methods would require carpet to be cut to allow access to the pad in these tight areas. The benefit of not cutting seams in the carpet, which minimizes the risk of damage, is it allows for proper and acceptable re-installation.

An additional advantage is that the disclosed embodiments minimize the time to remove pad by eliminating the need to uninstall a majority of the carpet in an area, as only a section will need to be uninstalled. The quicker the affected pad is removed, the sooner the drying process is able to begin.

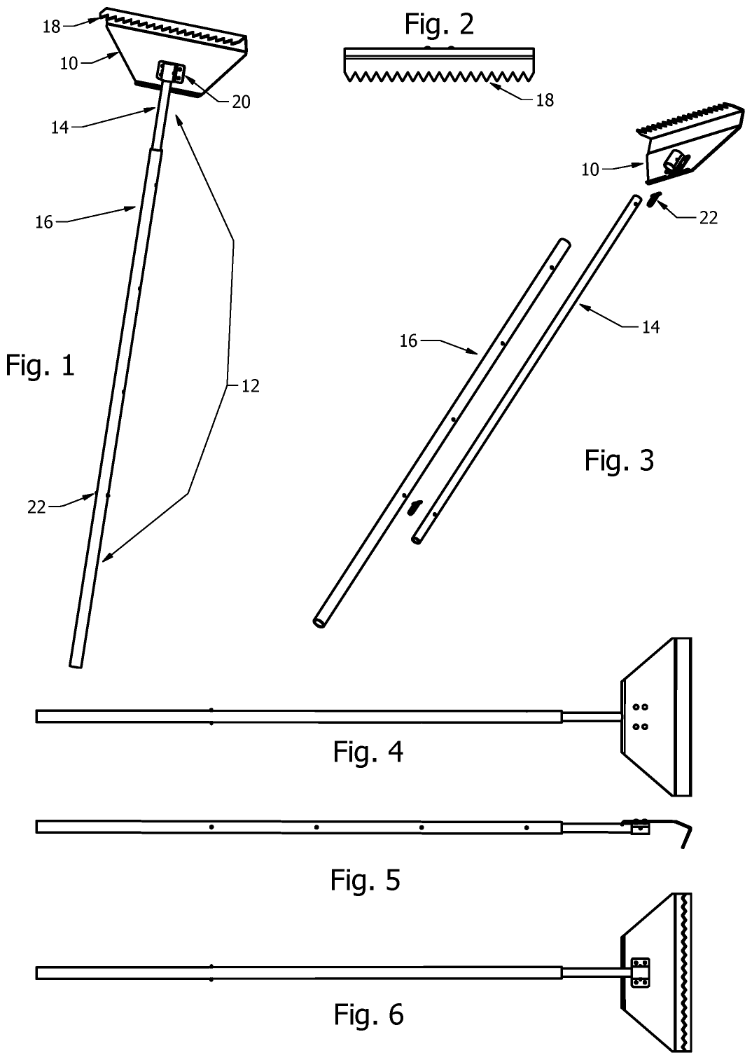

The disclosed embodiments remove pad from underneath installed or partially removed carpet. Some embodiments utilize a tool such as that shown in the non-limiting example embodiments in FIGS. 1-6. The non-limiting example in FIG. 1 is shown in perspective view. It is composed of a headplate 10 that may be attached to an extendable handle 12. The end of the handle may slide into a bracket 20, or any other handle attachment point, attached to the bottom of headplate 10 and may be fixed in place with spring push buttons 22, as seen in the non-limiting example embodiment in FIG. 3. In some embodiments, handle 12 may be composed of tubes with different diameters, possibly preferably made out of fiberglass or metal in some embodiments. In some embodiments, smaller diameter inner tube 14 may slide into the larger diameter outer tube 16 and in some embodiments may lock in place with a spring push button 22 allowing the handle length to be adjustable. As noted below, headplate 10 may be made from aluminum plate or sheet metal that is wide enough to make each pass efficient while still allowing for maneuverability. In some embodiments, headplate 10 may have teeth 18 along one edge, as seen in the non-limiting example embodiment in FIG. 2. In some embodiments, the side with the teeth may be rolled, bent or curved so that the teeth are facing downwards and back towards the handle with an angle that will allow for effectively removing the pad. In some embodiments, sides and edges may have been rolled down or smoothed as needed to prevent the tool from snagging the backside of the carpet.

The disclosed embodiments may be used on a water damage job with water intrusion affecting carpet and pad. A user may disengage and remove a section of carpet from the tack strip in the area where the affected pad needs to be removed. In some embodiments, the handle 12 may be adjusted to the desired length to reach the affected pad by sliding the smaller diameter tube 14 in or out of the larger diameter tube 16. The user may insert the tool, with the teeth 18 facing down, under the carpet but on top of the pad, holding the handle 12 as close to the floor as possible. The user may then lift up on the handle as much as is allowed without stretching the carpet and begin to retrieve the handle 12 from under the carpet, pulling and removing the pad with it. In some embodiments, the user may remove the pad in segmented sections, starting with the pad closest to the user and with each pass removing the pad farther into the room. The angle of the teeth and the weight of the carpet may allow the teeth to grab the pad and retrieve it from under the carpet with minimal removing, uninstalling or cutting of the carpet. In tighter and more restricted areas, where seams normally would need to be cut, the user may adjust the length of the handle, allowing room to insert the tool under the carpet. Removing pad using the disclosed embodiments allow for a larger portion of the carpet to stay installed and in one piece during the drying out process. This greatly reduces the risk of damaging carpet, allows for a quicker drying process due to removing excess water absorbed into the pad and saves time and effort previously required to remove pad.

It should be noted that the example embodiments described above are non-limiting, and several additional alternatives embodiments are also considered in this detailed disclosure. In some embodiments, different sizes, colors, shapes, interconnections, and materials (e.g., wood, fiberglass, other metals, and the like), may be used for all components. In some embodiments, a pin, bolt, twist/friction lock or other mechanism of any sort may be used in lieu of a push button, to attach the handle to the headplate or to connect the different sections of the handle as well as allowing for extending or shortening the handle to the desired length. In some embodiments, the handle may be permanently fixed to the head. In some embodiments, the handle may be adjusted using different methods and configurations. In some embodiments, the teeth may have different configurations. As non-limiting examples, the teeth may be sharper, duller, longer, shorter, may have different angles, may be shaped differently or spaced closer or farther apart, and the like. In some embodiments, the handle can be longer or shorter. In some embodiments, the headplate may have different shapes and sizes that will allow for the same result of removing pad under installed or partially removed carpet. In some embodiments, the handle may have a grip, knurling or other finish on it. In some embodiments, In some embodiments, the handle may be made of fiberglass or like material, and the head portion, which may include a raking tool, may be made of plastic or other like material.

Other embodiments and uses of the above disclosures will be apparent to those having ordinary skill in the art upon consideration of the specification and practice of the embodiments disclosed herein. The specification and examples given should be considered exemplary only, and it is contemplated that the appended claims will cover any other such embodiments or modifications as fall within the true scope of the disclosure.

The Abstract accompanying this specification is provided to enable the United States Patent and Trademark Office and the public generally to determine quickly from a cursory inspection the nature and gist of the technical disclosure and in no way intended for defining, determining, or limiting the present disclosure or any of its embodiments.

1. A carpet pad removal tool, comprising:
a handle; and
a headplate coupled to the handle, the headplate including a plurality of teeth along an edge of the headplate, wherein the edge of the headplate is angled relative to the headplate.

2. A method of removing carpet pad, comprising:
inserting a pad removal tool under a section of carpet and on top of a carpet pad located beneath the carpet, wherein the pad removal tool includes
a handle, and
a headplate coupled to the handle, the headplate including a plurality of teeth along an edge of the headplate, wherein the edge of the headplate is angled relative to the headplate;
engaging the plurality of teeth of the pad removal tool into the carpet pad; and
pulling the handle of the pad removal tool out from under the carpet and removing a portion of the carpet pad from under the carpet.
